(19) United States
(12) Patent Application Publication
(10) Pub. No.: US 2013/0129412 A1
(43) Pub. Date: May 23, 2013

(54) SHELVING PANEL CONNECTOR

(71) Applicant: John WHALEN, Sheridan, IL (US)

(72) Inventor: John WHALEN, Sheridan, IL (US)

(21) Appl. No.: 13/680,920

(22) Filed: Nov. 19, 2012

Related U.S. Application Data
(60) Provisional application No. 61/560,951, filed on Nov. 17, 2011.

(51) Int. Cl. F16B 12/10

(52) U.S. Cl. CPC F16B 12/10
USPC 403/292

(57) ABSTRACT

The disclosure includes a connector that facilitates increased strength and stability of a shelving unit. The connector may include a main panel having an upper surface and a lower surface. A plurality of top protrusions may extend from the upper surface of the main panel. One or more of the plurality of top protrusions may be configured to fit with a recess associated with a shelving panel. In addition, at least one bottom protrusion may extend from the lower surface of the main panel. The bottom protrusion may include a recess that may be configured to receive and engage a pole.

### CROSS REFERENCE TO PRIOR APPLICATION

This application claims priority to and the benefit thereof from U.S. Provisional Patent Application No. 61/560,951, filed on November 2011, titled “Shelving Panel Connector,” the entirety of which is hereby incorporated herein by reference.

### BACKGROUND OF THE DISCLOSURE

1. Field of the Disclosure

This disclosure is directed to a shelving unit connector, and more particularly to a shelving unit connector for connecting shelving panels horizontally and supporting shelving units vertically.

2. Related Art

Self-assembly shelves are widely shelves available, inexpensive and easy to assemble and maintain, and, hence, commonly used in a storage area such, e.g., a basement, garage, laundry room, or the like. Such shelves may be easily assembled by interconnecting two or more shelving panels vertically with a plurality of poles. However, such a shelving unit may often be associated with limited structural strength and stability. As a result, contemporary shelving units may be associated with relatively modest maximum loading weights. Accordingly, there is a need for an economical solution for improving structural strength, stability and maximum loading weights of self-assembly shelves.

### SUMMARY OF THE DISCLOSURE

According to one aspect of the disclosure, a connector is provided that comprises: a main panel including an upper surface and a lower surface; a plurality of top protrusions that extend from the upper surface of the main panel, wherein the plurality of top protrusions are each configured to fit with a bottom surface of a shelving panel; and, at least one bottom protrusion that extends from the lower surface of the main board, wherein the at least one bottom protrusion is configured to support a shelving panel.

The plurality of top protrusions may comprise at least a first top protrusion and a second top protrusion, and the second top protrusion may be configured to be shorter than the first top protrusion. In addition, at least one of the plurality of top protrusions may comprise a rib.

The plurality of top protrusions may comprise at least a first top protrusion, a second top protrusion, and a third top protrusion, and the third top protrusion may be configured to be shorter than the first top protrusion and the second top protrusion.

The bottom protrusion may include a recess, and the recess may overlap at least one of the plurality of top protrusions.

The connector may be configured to include at least one flange.

The bottom protrusion may include a recess, and the recess may be shaped to receive and engage a pole.

The shape of the recess may be substantially cylindrical.

Another aspect of the disclosure may provide a connector configured to connect a plurality of shelving panels, comprising: a main panel including an upper surface and a lower surface; and, a plurality of top protrusions that extend from the upper surface of the main panel, wherein the plurality of top protrusions include at least a first top protrusion and a second top protrusion, wherein the first top protrusion is configured to fit with a recess of a first shelving panel, wherein the second top protrusion is configured to fit with a recess of a second shelving panel; and, at least one bottom protrusion that extends from the lower surface of the main panel.

The second top protrusion may be configured to be shorter than the first top protrusion.

The bottom protrusion may include a recess, and the recess may overlap at least one of the plurality of top protrusions.

The connector may be configured to include at least one flange.

The bottom protrusion may include a recess, and the recess may be shaped to receive and engage a pole.

The shape of the recess may be substantially cylindrical.

Another aspect of the disclosure may provide a connector configured to connect a plurality of shelving panels, comprising: a main panel including an upper surface and a lower surface; and, at least one top protrusion that extends from the upper surface of the main panel; and, at least one bottom protrusion that extends from the lower surface of the main panel, wherein the bottom protrusion includes a recess configured to receive a pole.

The upper surface of the main panel may include a plurality of top protrusions.

The plurality of top protrusions may include a first top protrusion and a second top protrusion, and the second top protrusion may be smaller than the first top protrusion.

The plurality of top protrusions may include a first top protrusion, a second top protrusion, and a third top protrusion, and the third top protrusion may be smaller than the first top protrusion and the second top protrusion.

The first top protrusion may be configured to fit with an outer recess of a first shelving panel, and the second top protrusion may be configured to fit with an inner outer recess of the first shelving panel.

The shape of the recess may be substantially cylindrical.

The connector may be configured to include at least one flange.

Additional features, advantages, and embodiments of the disclosure may be set forth or apparent from consideration of the detailed description and drawings. Moreover, it is to be understood that the foregoing summary of the disclosure and the following detailed description and drawings are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a perspective view of a connector for a shelving panel constructed according to the principles of the disclosure;

FIG. 2 shows a bottom perspective view of a shelving panel with the connector of FIG. 1 attached thereto;

FIG. 3 shows a bottom perspective view of a shelving panel with two connectors of FIG. 1 attached thereto; and

FIG. 4 shows a bottom perspective view of two shelving panels adjoined by the two connectors of FIG. 1.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

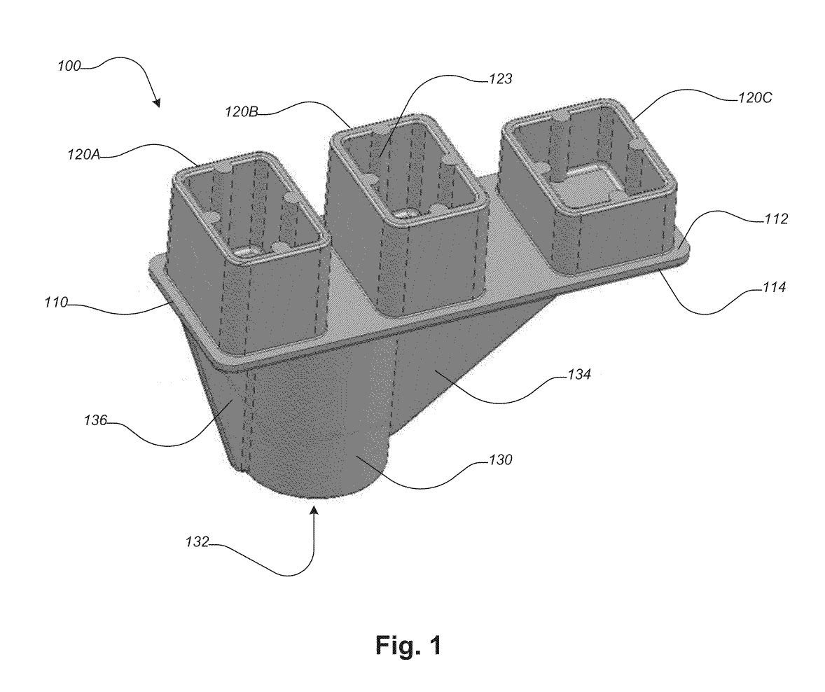

FIG. 1 shows a perspective view of a connector 100 for a shelving panel according to one aspect of the disclosure. The connector 100 may include a main panel 110 having an upper surface 112 and a lower surface 114. The connector 100 may also include a plurality of top protrusions 120, such as, e.g., a first top protrusion 120A, a second top protrusion 120B, and a third top protrusion 120C that may each extend upwardly from the upper surface 112 of the main panel 110. In addition, the connector 100 may also include at least one bottom protrusion 130 that may extend downwardly from the lower surface 114 of the main panel 110. Each of the top protrusions 120 may include one or more longitudinal ribs 123, which may provide, e.g., added rigidity and strength to the protrusions 120. The bottom protrusion 130 may also include one or more longitudinal ribs (not shown) to provide, e.g., added rigidity and strength.

The first and second top protrusions 120A and 120B may have substantially the same shape and height. For example, the first and second top protrusions 120A and 120B may be substantially rectangular shape, as seen in FIG. 1. In addition, e.g., the first and second top protrusions 120A and 120B may have substantially the same height when height is measured as the distance that a protrusion extends from a surface of the main panel 110.

The third top protrusion 120C may also have a substantially rectangular shape. However, the shape and/or configuration of the third top protrusion 120C may be different from that of the first and second top protrusions 120A and 120B. For example, the third top protrusion 120C may have a different shape than the first and second top protrusions 120A and 120B. Alternatively, or in addition, e.g., the third top protrusion 120C may have a shorter height than the first and second top protrusions 120A and 120B.

While the top protrusions 120A-120C are shown as having a substantially rectangular shape, the top protrusions 120A-120C may have a shape that is, e.g., substantially square, diamond, circular, triangular, trapezoidal, polygonal, pentagonal, oval, star-shaped, or the like. The shapes of the top protrusions 120A, 120B, and 120C may be substantially the same, or different.

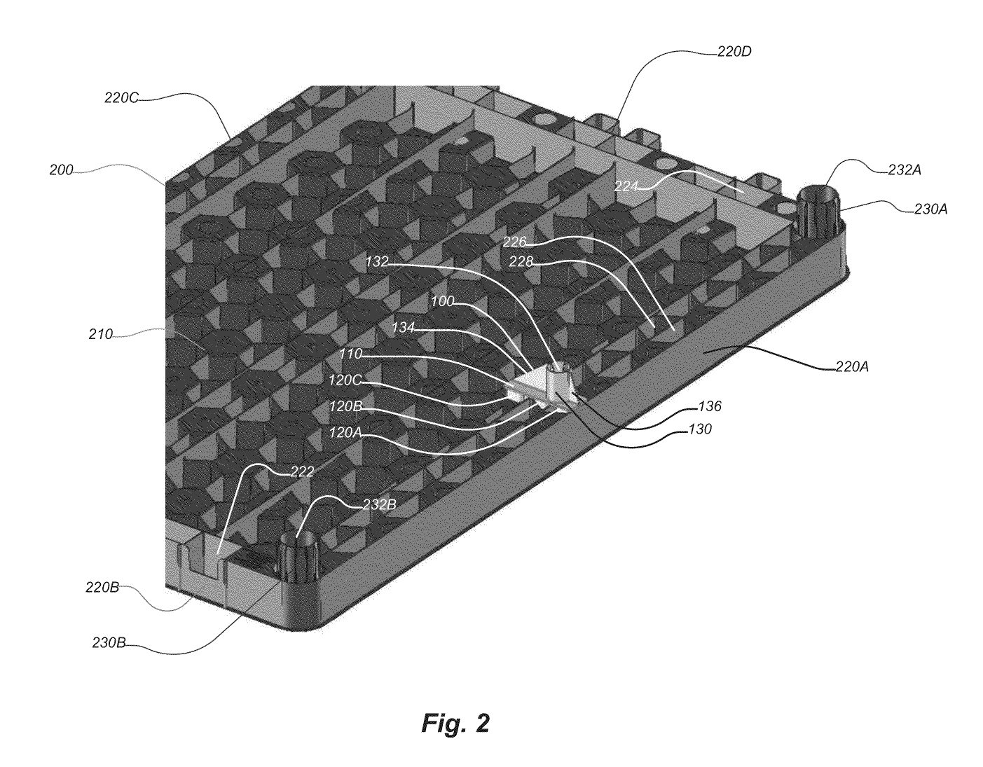

The top protrusions 120 may be particularly shaped to fit with one or more recesses of a shelving panel (shown in FIGS. 2, 3, and 4). For example, the top protrusions 120 may have a hollow rectangular pillar shape as shown in FIG. 1. Such a shape may be desirable if the recess for which the top protrusion 120 is configured to fit with is also substantially rectangular. However, an aspect of the disclosure contemplates that recesses may be designed with a variety of different shapes and/or configurations.

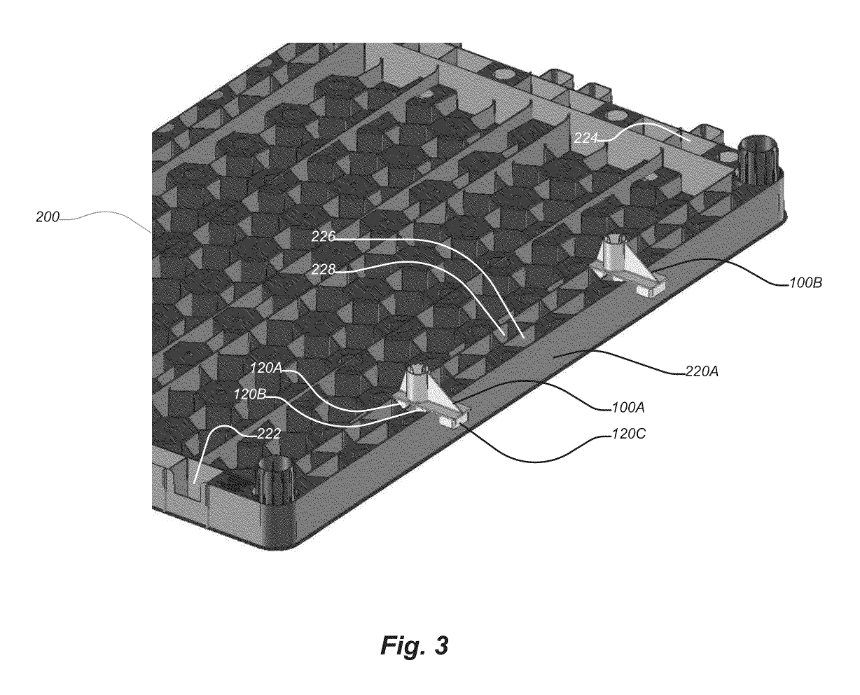

In accordance with one aspect of the disclosure, e.g., the top protrusions 120 may be shaped to fit into a recess, such as, e.g., recesses 226 and 228 (shown in FIG. 2), that are formed on a bottom surface of one or more shelving panels, such as, e.g., shelving panels 200 and/or 200′ shown in FIGS. 2, 3, and/or 4. For example, the top protrusions may have a trapezoidal shape that conforms to recesses 226 and 228.

Accordingly, it will readily apparent to one of ordinary skill in the art, in view of the instant disclosure, that the top protrusions 120A-120C may be shaped and/or configured to fit with any recesses that may reside on a surface of a shelving panel, such as, e.g., shelving panel 200 or 200′. For example, the shape of the one or more top protrusions 120 may include a square, rectangle, diamond, trapezoid, polygon, pentagon, circle, oval, or the like. The plurality of protrusions may also be configured, e.g., to extend from the main panel 110 in any manner that still achieves the benefit of the instant disclosure, as described herein. In addition, it is also contemplated that the number of top protrusions 120 on any given connector 100 may vary and the top protrusions 120 may be, e.g., hollow, have a sealed top surface, or be non-hollow.

The bottom protrusion 130 may extend downwardly from the lower surface 114 of the main panel 110. The bottom protrusion 130 may have a cylindrical shape that is configured to facilitate a recess 132 for receiving and engaging an end of a supporting pole (not shown). However, other shapes and configurations are also contemplated. For example, the shape of the bottom protrusion 130 may vary depending on the shape of a supporting pole. As such the recess 132 may be shaped such that the recess may receive and engage a supporting pole having a pole end that may be, e.g., a cylindrical, cubic, triangular, pentagonal, trapezoidal, or hexagonal, etc.

The bottom protrusion 130 may be positioned such that the bottom protrusion 130 is closer to an end of the main body 110 and may overlap at least one of the first and second top protrusions 120A and 120B, as shown in FIG. 1. However, it is also contemplated that the bottom protrusion 130 may be positioned in any location on the bottom surface 114 that facilitates the benefits of the disclosure set forth herein. In addition, the bottom protrusion 130 may include one or more flanges, such as, e.g., flanges 134 and 136, as shown in FIG. 1, to increase support strength.

FIG. 2 shows a bottom perspective view of the shelving panel 200 with a connector 100 attached thereto. The shelving panel 200 may have a substantially flat upper surface (not shown), a bottom surface that may include one or more rows of outer recesses 222, 224, 226, 228, and a plurality of corner units 230 that are formed at the corners of shelving panel 200.

The bottom of the shelving panel 200 may include a main portion 210 and edges 220 that surround the main portion 210. The edges 220 may include, e.g., a first edge 220A, a second edge 220B, a third edge 220C and a fourth edge 220D. The edges 220 may be thicker than the main portion 210 and further extend downwardly beyond the main portion 210. The main portion 210 may include a honeycomb surface pattern. However, the bottom of the shelving panel 200 may be designed to include any surface pattern that may include recesses to facilitate the attachment of one or more connectors 100.

Each edge 220 may be associated with a surface pattern that creates one or more rows of recesses. For example, the second edge 220B and fourth edge 220D may each include a single row of outer recesses 222 and 224 respectively. Alternatively, or in addition, e.g., the first edge 220A and the third edge 220C may each include more than a single row of outer recesses, such as, e.g., a first row of outer recesses 226 and a second row of inner outer recesses 228. As shown in FIG. 2, the inner outer recesses 228 may be neighboring each other while the outer recess 226 may be spaced apart from each other by the surface pattern. As noted above, the openings of the recesses 226 and 228 may have a trapezoid shape, or any other shape, that facilitates the attachment of one or more connectors 100.

Each of the corner units 230 may include at least one corner recess 232. Each corner recess 232 may be configured to receive and engage a first end of a pole (not shown). The opposite end of the pole may be connected to a corner recess of another shelving panel that is substantially similar to the corner recess 232 shown in shelving panel 200. As a result, one of ordinary skill in the art may interconnect a plurality of shelving panels vertically with a plurality of poles in order to form a shelf (not shown) such as, e.g., the shelf described in U.S. patent application Ser. No. 11/894,118 filed on Aug. 20, 2007, which is herein incorporated by reference in its entirety.

A connector 100 may be attached to the shelving panel 200 in a manner that facilitates the incorporation of an additional pole (not shown). For example, the connector 100 may be attached such that, e.g., the connector fits with one or more recesses associated with the first edge 220A and positioned between two corner recesses 232A and 232B. Specifically, e.g., the first and second top protrusion 120A and 120B may be inserted into the outer recess 226 and the inner outer recess 228, respectively, in order to attach the connector 100 to shelving panel 200 at or near the edge 220A. Furthermore, in accordance with this example, top protrusion 120C may fit with, e.g., an outer wall of inner outer recess 228 and/or one or more additional recesses within the main portion 210 of shelving panel 200. In addition, top protrusion 120C may be shorter than top protrusions 120A and 120B, and thus, may stay clear from or barely contact the main portion 210. Attaching the connector 100 to the shelving panel 200 in such a manner results in a configuration of components that allows connector 100, corner recess 232A, and corner recess 232B to each receive a pole. Therefore, at least one aspect of the present disclosure may provide, e.g., a connector 100 that may function to reinforce a shelf by facilitating the addition of another pole to increase support and stability of a shelf.

The connector 100 may even provide increased support and stability of a shelf when attached to shelving panel 200 that is positioned as the lowest shelving panel of a shelving unit. This is because the connector 100 may provide vertical support and stability by, e.g., the bottom protrusion 130 contacting a floor.

The diameters of the recess 132 and the corner recesses 232 may be sized in order to fit with a pole. The recess 132 and corner recess 232 may be configured to have different diameters, e.g., the recess 132 may have a smaller diameter than the corner recess 232 or the recess 132 may have a larger diameter than the corner recess 232. Alternatively, however, the recess 132 and the corner recess 232 may be configured to have substantially the same diameter such that poles of substantially the same size may be universally used to fit with both the recess 132 and the corner recess 232.

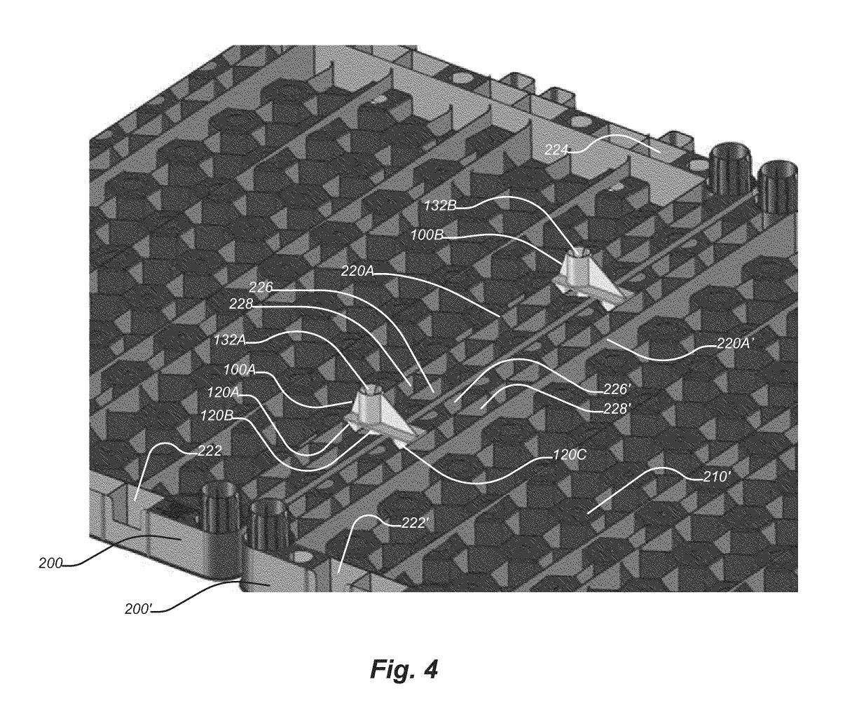

FIG. 3 shows an alternative view of the bottom surface of shelving panel 200 that highlights an additional application of the connector 100. In addition to providing increased support and stability, the connector 100 may be used to connect a plurality of shelving panels 200 and 200′ (see FIG. 4). In order to connect shelving panels 200 and 200′ (see FIG. 4), the connectors 100 may be attached to the shelving panel 200 as shown in FIG. 3.

As shown in FIG. 3, a plurality of connectors 100A and 100B may be attached to the shelving panel 200 in order to facilitate the connection of a plurality of shelving panels. The connection of a plurality of shelving panels may be facilitated by, e.g., rotating the connectors 100A, 100B about 180 degrees from the position of connector 100 in FIG. 2 and attaching the connectors 100A, 100B to shelving panel 200. Specifically, e.g., the first and second top protrusion 120A and 120B may be inserted into the inner outer recess 228 and the outer recess 226, respectively, in order to attach the connectors 100A, 100B to shelving panel 200 at or near the edge 220A. Further, in accordance with this example, top protrusion 120C may not fit with any recess of shelving panel 200. Instead, in accordance with this example, the portions of the connectors 100A, 100B that include top protrusion 120C each may extend outwardly away from edge 220A. Top protrusion 120C may extend away from edge 220A in a manner that facilitates a connection to another shelving panel 200 (shown in FIG. 4). In addition, top protrusion 120C may be shorter than top protrusions 120A and 120B, and thus, may stay clear from or barely contact the main portion 210′ and 220A′ (shown in FIG. 4) This additional function of the connector 100 may be desirable, e.g., to expand the upper surface area of an existing shelf. As a result, it will be readily apparent to one of ordinary skill in the art, in view of the instant disclosure, that the connector 100 may be multi-functional.

FIG. 4 shows an example that includes two shelving panels 200 and 200′ being connected by connectors 100A and 100B. As shown in FIG. 4, the third top protrusion 120C may be inserted into an outer recess 226′ of another shelving panel 200′, thereby connecting the edges 220A and 220A′ of shelving panels 200 and 200′ respectively. In addition, poles may be inserted into recesses 132A and 132B in order to provide increased support and stability for shelving panels 200 and 200′.

Accordingly, the invention provides an economical solution for improving structural strength, stability, and maximum loading weights of shelves that may be, e.g., self-assembled. However, it is also noted that self-assembly of a shelf using the components described by this disclosure need not be required. This is because, e.g., it is contemplated that the components described by this disclosure such as, e.g., the connector 100, shelving panel 200, and pole may also be mass produced as part of a fully assembled shelf. Nevertheless, the described connectors 100 and shelving panels 200 may be interconnected vertically and horizontally in the matter described, thereby providing a larger, and more stable, shelving space.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A connector, comprising:
a main panel including an upper surface and a lower surface;
a plurality of top protrusions that extend from the upper surface of the main panel, wherein the plurality of top protrusions are each configured to fit with a bottom surface of a shelving panel; and,
at least one bottom protrusion that extends from the lower surface of the main board, wherein the at least one bottom protrusion is configured to support a shelving panel.

2. The connector of claim 1,
wherein the plurality of top protrusions comprises at least a first top protrusion and a second top protrusion,
wherein the second top protrusion is configured to be shorter than the first top protrusion,
wherein at least one of the plurality of top protrusions comprises a rib.

3. The connector of claim 1,
wherein the plurality of top protrusions comprises at least a first top protrusion, a second top protrusion, and a third top protrusion,
wherein the third top protrusion is configured to be shorter than the first top protrusion and the second top protrusion.

4. The connector of claim 1,
wherein the bottom protrusion includes a recess,
wherein the recess overlaps at least one of the plurality of top protrusions.

5. The connector of claim 1,
wherein the connector is configured to include at least one flange.

6. The connector of claim 1,
wherein the bottom protrusion includes a recess,
wherein the recess is shaped to receive and engage a pole.

7. The connector of claim 6,
wherein the shape of the recess is substantially cylindrical.

8. A connector configured to connect a plurality of shelving panels, comprising:
a main panel including an upper surface and a lower surface; and,
a plurality of top protrusions that extend from the upper surface of the main panel,
wherein the plurality of top protrusions include at least a first top protrusion and a second top protrusion,
wherein the first top protrusion is configured to fit with a recess of a first shelving panel,
wherein the second top protrusion is configured to fit with a recess of a second shelving panel; and,
at least one bottom protrusion that extends from the lower surface of the main panel.

9. The connector of claim 8,
wherein the second top protrusion is configured to be shorter than the first top protrusion.

10. The connector of claim 8,
wherein the bottom protrusion includes a recess,
wherein the recess overlaps at least one of the plurality of top protrusions.

11. The connector of claim 8,
wherein the connector is configured to include at least one flange.

12. The connector of claim 8,
wherein the bottom protrusion includes a recess,
wherein the recess is shaped to receive and engage a pole.

13. The connector of claim 12,
wherein the shape of the recess is substantially cylindrical.

14. A connector configured to connect a plurality of shelving panels, comprising:
a main panel including an upper surface and a lower surface; and,
at least one top protrusion that extends from the upper surface of the main panel; and,
at least one bottom protrusion that extends from the lower surface of the main panel, wherein the bottom protrusion includes a recess configured to receive a pole.

15. The connector of claim 14,
wherein the upper surface of the main panel includes a plurality of top protrusions.

16. The connector of claim 15,
wherein the plurality of top protrusions includes a first top protrusion and a second top protrusion,
wherein the second top protrusion is smaller than the first top protrusion.

17. The connector of claim 15,
wherein the plurality of top protrusions includes a first top protrusion, a second top protrusion, and a third top protrusion,
wherein the third top protrusion is smaller than the first top protrusion and the second top protrusion.

18. The connector of claim 17,
wherein the first top protrusion is configured to fit with an outer recess of a first shelving panel,
wherein the second top protrusion is configured to fit with an inner outer recess of the first shelving panel.

19. The connector of claim 14,
wherein the shape of the recess is substantially cylindrical.

20. The connector of claim 14,
wherein the connector is configured to include at least one flange.
